(19) United States
(12) Patent Application Publication
(10) Pub. No.: US 2015/0084315 A1
(43) Pub. Date: Mar. 26, 2015

(54) VEHICLE PASSENGER PROTECTION SYSTEM

(71) Applicant: TRW Automotive GmbH, Alfdorf (DE)

(72) Inventors: Dominique Acker, Gschwend (DE); Marco Wahl, Sulzbach-Laufen (DE)

(21) Appl. No.: 14/396,110

(22) PCT Filed: Apr. 23, 2013
(86) PCT No.: PCT/EP2013/001223

§ 371 Date: Oct. 22, 2014

(30) Foreign Application Priority Data
Apr. 26, 2012 (DE) 10 2012 008 390.4

(51) Int. Cl. B60R 21/20; B60R 21/207; B60R 21/231

(52) U.S. Cl. CPC B60R 21/20; B60R 21/231; B60R 21/207
USPC 280/728.2; 280/730.1

(57) ABSTRACT

A vehicle occupant protection system comprises an airbag (20) which in the folded state is accommodated in a backrest (14) of a vehicle seat (12) and in the deployed state extends between two seats (12, 52) of the vehicle. The airbag (20) includes a thorax zone (36) for laterally covering the thorax of a vehicle occupant (40) and a head zone (38) for laterally covering the head (42) of a vehicle occupant (40). A first fastening portion (22) which is directly arranged on an inflator (26) supplying filling gas for the airbag (20) is provided on the airbag and a second fastening portion (24) is provided which is arranged at the thorax zone (36) between the first fastening portion (22) and an upper end (16) of the backrest (14).

### RELATED APPLICATIONS

This application corresponds to PCT/EP2013/001223, filed Apr. 23, 2013, which claims the benefit of German Application No. 10 2012 008 390.4, filed Apr. 26, 2012, the subject matter of which are incorporated herein by reference in their entirety.

### BACKGROUND OF THE INVENTION

The invention relates to a vehicle occupant protection system comprising an airbag.

Considerations have been made to arrange an airbag between two vehicle seats so as to prevent collision of the vehicle occupants in the case of a side crash. Such vehicle occupant protection system is described, for example, in DE 10 2009 014 103 A1. The catching distance for such vehicle occupant protection system is short and the airbag must have a relatively large surface so that its deployment is time-critical. Therefore it is of advantage to avoid strong oscillating movements during deployment of the airbag as well as in the deployed state thereof.

### SUMMARY OF THE INVENTION

It is the object of the invention to provide a vehicle occupant protection system in which such airbag adopts its optimum position within short time.

In accordance with the invention, for this purpose a vehicle occupant protection system is provided with an airbag which is accommodated in the folded state in a backrest of a vehicle seat and in the deployed state extends between two seats of the vehicle, the airbag having a thorax zone for laterally covering the thorax of a vehicle occupant and a head zone for laterally covering the head of a vehicle occupant, wherein a first fastening portion which is provided directly on an inflator supplying filling gas for the airbag is provided on the airbag, and a second fastening portion which is arranged at the thorax zone between the first fastening portion and an upper end of the backrest is provided on the airbag.

The second fastening portion stabilizes the airbag by an additional connecting point fixed on the vehicle, thereby oscillating movements being significantly reduced and the airbag being capable of more quickly adopting its optimum deployed position.

The airbag deploys, as known side airbags, out of the backrest of the vehicle seat but is arranged on the side of the backrest facing the neighboring vehicle seat, i.e. not in the seat side facing the vehicle wall or door.

The airbag extends substantially in a plane between the vehicle seats and approximately in parallel to a vehicle side wall. The backrest does not comprise the headrest which is considered here to be a separate part connected to the upper end of the backrest.

In total, the airbag is configured so that it can also catch a vehicle occupant on a neighboring vehicle seat so as to offer better protection to this vehicle occupant in the case of a side impact.

Preferably the second fastening portion is arranged beneath a shoulder of a 95% male dummy. It has turned out that in this way an excellent protective effect can be achieved for both vehicle occupants seated next to each other.

The second fastening portion is preferably arranged to be spaced from the upper end of the backrest of the vehicle seat, for example about 10 to 30 cm beneath the upper end of the backrest.

The protection by the airbag is ensured for the vehicle occupant on the neighboring vehicle seat (i.e. on the seat on which the airbag is not fastened) both when the vehicle seats are on the same level related to the longitudinal vehicle direction, and when the vehicle seats are offset against each other somewhat in the longitudinal vehicle direction. Also in the event of impact with offset vehicle seats the second fastening portion ensures sufficient stability of the airbag.

The second fastening portion can be fastened direction to a frame of the backrest. This is an inexpensive alternative, as no additional components have to be provided.

However, it is also possible to fasten the second fastening portion on a fastening component separate from a frame of the backrest, wherein then the fastening component is in turn directly connected to the frame of the backrest. In this variant, different geometries of the airbag and the backrest can be taken into account in a simple manner.

It is possible to design the separate fastening component so that also the first fastening portion is directly fixed to the fastening component. It is equally possible to arrange also the inflator directly on the fastening component.

In each case, the first fastening portion is preferably fastened via fastening bolts of the inflator on the frame of the backrest so that also in this case no additional components have to be provided.

An upper end of the airbag preferably extends at least to an upper end of a headrest, i.e. definitely beyond the upper end of the backrest, and the second fastening portion is arranged approximately in the middle between an upper end of the backrest and the first fastening portion. It has turned out that this geometry permits appropriate stabilization of the airbag in the case of a large surface covered by the airbag.

The second fastening portion is an eyelet, for example.

The airbag may consist of two cut portions interconnected along a peripheral fastening, wherein the second fastening portion is arranged at the peripheral fastening.

It is also possible, as a matter of course, to manufacture the cut portions to be integrally connected on one side and to superimpose them or to manufacture the entire airbag by a one-piece weaving method.

The head zone of the airbag preferably has a larger width that the thorax zone, wherein the deployed airbag is especially L-shaped. The wider head zone increases the protection offered by the airbag for the head of the vehicle occupants.

It is equally advantageous when the head zone of the airbag completely covers a headrest of the vehicle seat and the head of the vehicle occupant on the vehicle seat.

### BRIEF DESCRIPTION OF THE DRAWINGS

Hereinafter the invention shall be described in detail by way of two embodiments with respect to the enclosed drawings, in which:

FIG. 1 shows a schematic side view of a vehicle occupant protection system according to the invention in accordance with a first embodiment;

FIG. 2 shows a schematic side view of a vehicle occupant protection system according to the invention in accordance with a second embodiment;

FIG. 3 shows a further schematic view of a vehicle occupant protection system according to the invention;

FIG. 4 shows a schematic top view onto a vehicle occupant protection system according to the invention in the case of a purely lateral pole impact with the seating positions being on the same level;

FIG. 5 shows a schematic top view onto a vehicle occupant protection system according to the invention in the case of purely lateral pole impact with the seating positions being offset;

FIG. 6 shows a schematic top view onto a vehicle occupant protection system according to the invention in the case of an inclined pole impact with the seating positions being on the same level; and

FIG. 7 shows a schematic top view onto a vehicle occupant restraint system according to the invention in the case of an inclined pole impact with the seating positions being offset.

### DESCRIPTION OF EMBODIMENTS

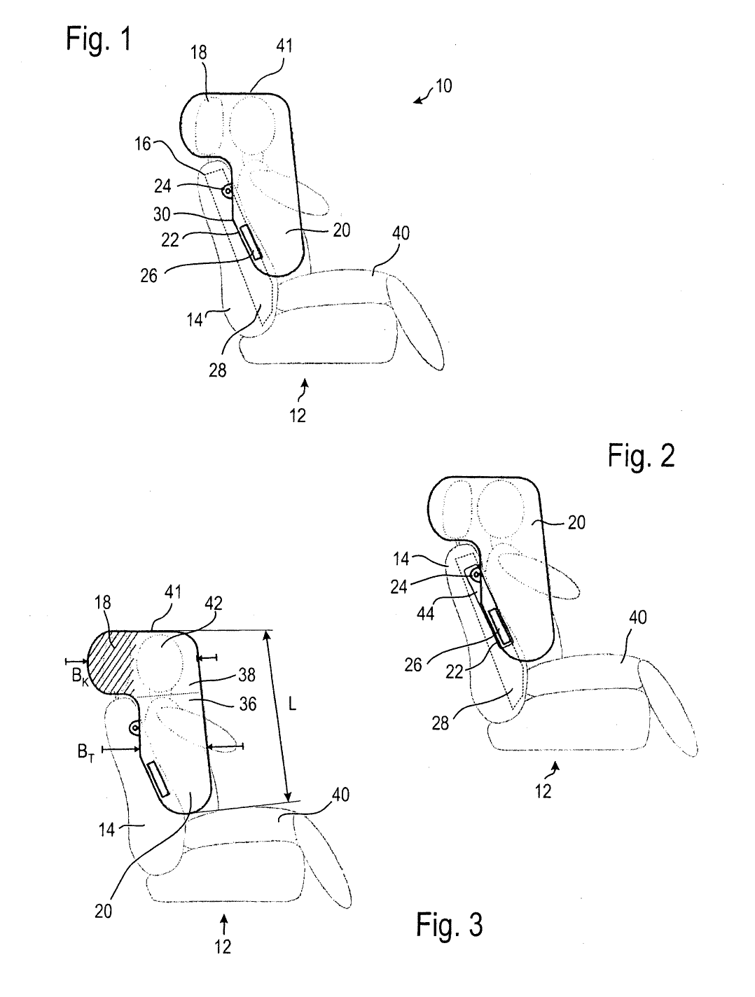

FIG. 1 illustrates a vehicle occupant protection system 10 comprising a vehicle seat 12 having a seat cushion and a backrest 14 extending upwards. At an upper end 16 of the backrest 14 a separate headrest 18 is arranged.

An airbag 20 having the shape of a large inverted L in the deployed and inflated state is fastened to the backrest 14 and before being activated is accommodated in the backrest 14 in a known manner (not shown).

The airbag 20 includes two fastening portions 22, 24 at which it is connected to the backrest 14.

The first fastening portion 22 is arranged directly at an inflator 26 supplying filling gas for the airbag 20. For example, it consists of one or two apertures in the airbag 20 through which fastening bolts of the inflator 26 (not shown) are passed. The fastening bolts of the inflator 26 are fastened to a frame 28 of the backrest 14 in the known manner.

The second fastening portion 24 is formed by an eyelet at a peripheral fastening 30 of the airbag 20 in this case.

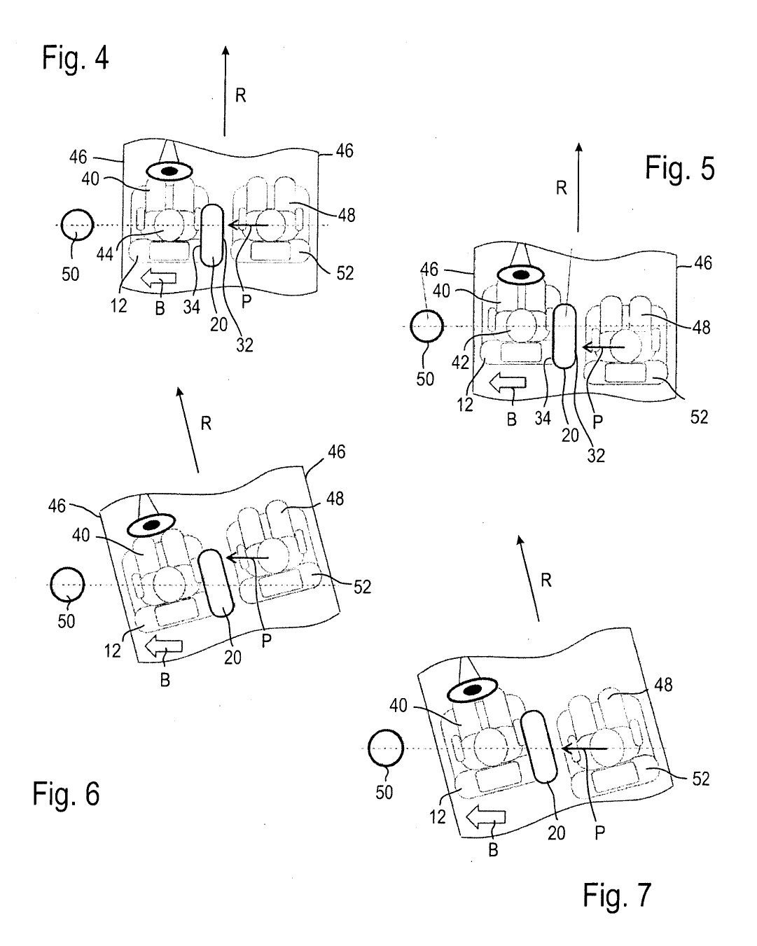

The peripheral fastening 30 can be formed, for example, by stitching or interweaving two cut portions 32, 34 constituting the airbag 20 (indicated in FIG. 4).

The airbag 20 is (theoretically) divided into a thorax zone 36 and a head zone 38 directly connected thereto (cf. FIG. 3). The thorax zone 36 has a width B_{T} in the longitudinal vehicle direction R (cf. FIG. 4) and approximately perpendicular to the longitudinal extension L of the airbag 20 along the backrest 14 which amounts to approximately half to ⅔ of the width B_{K} of the head zone 38. The head zone 38 thus has a definitely larger width B_{K} than the thorax zone 36 of the airbag 20.

The width B_{T} of the thorax zone 36 is selected to be so large, however, that the entire thorax of the vehicle occupant 40 seated on the vehicle seat 12 is covered. The width B_{K} of the head zone 38 is selected to be so large and the head zone 38 of the airbag 20 is arranged so that both the head 42 of the vehicle occupant 40 and the headrest 18 are completely covered on the side. In this way a characteristic inverted L shape is imparted to the airbag 20.

The second fastening portion 24 is arranged at the thorax zone 36 of the airbag 20. In the embodiment illustrated in FIG. 1 the second fastening portion 24 is fastened directly on the frame 28 of the backrest 14, for example by a screw projecting through the eyelet of the fastening portion 24.

The second fastening portion 24 is located somewhat beneath the upper end 16 of the backrest 14, for example 10 to 30 cm deeper. The second fastening portion 24 thus is arranged somewhat beneath the shoulder of the vehicle occupant 40, as is evident from FIGS. 1 to 3, wherein the vehicle occupant 40 shown here represents a 95% male dummy.

In the illustrated example, the second fastening portion 24 is located approximately in the middle between the upper end 16 of the backrest 14 and the first fastening portion 22 level with the inflator 26 and thus somewhat spaced apart from the (theoretical) limit between the head zone 38 and the thorax zone 36 (cf. FIG. 3).

The head zone 38 of the airbag 20 extends laterally against the longitudinal vehicle direction R to behind the headrest 18 of the vehicle seat 12. An upper end 41 of the airbag 20 extends beyond an upper end of the headrest 18.

In the longitudinal vehicle direction R the head zone 38 of the airbag extends to in front of the head 42 of the vehicle occupant 40 on the vehicle seat 12 to which the airbag 20 is fastened (in this case the driver seat).

The head zone 38 is so large that the head 44 of the vehicle occupant 40 seated on the vehicle seat 12 is completely covered, just as the headrest 18 of the vehicle seat 12 by the head zone 38 viewed from the side.

In the embodiment illustrated in FIG. 2 the second fastening portion 24 is not directly fastened to the frame 28 of the backrest 14 but to a fastening component 44 separate from the frame 28. The separate fastening component 44 in this case is an elongate fastening sheet extending from the second fastening portion 24 to the lower end of the inflator 26.

The first fastening portion 22, too, is connected to the fastening component 44.

For instance, the fastening component 44 includes apertures (not shown) through which the fastening bolts of the inflator 26 are protruding and by which the fastening component 44 is fastened to the frame 28 of the backrest 14.

A second fastening point of the fastening component 44 is preferably predefined by the fixing of the second fastening portion 24 to the frame 28 of the backrest 14.

The airbag 20, the inflator 26 and the fastening component 44 may constitute a pre-mounted subassembly which is screwed together for mounting the airbag system on the frame 28.

The airbag 20 is arranged on the side of the vehicle seat 12 facing away from a side wall 46 or door of the vehicle.

In FIGS. 4 to 7 the situation for an airbag 20 on a vehicle seat is shown, wherein the airbag 20 has deployed between the vehicle seat 12 and passenger seat 52.

In the case of a side impact (shown here by the situation during a pole test) onto an obstacle 50 located next to the vehicle side wall 46 adjacent to the driver seat 12, the airbag 20 is intended to absorb a movement of the passenger 48 on the passenger seat 52.

FIG. 4 illustrates a situation in which the vehicle is orientated in the longitudinal vehicle direction R and performs a movement directed perpendicularly to the direction R with respect to the obstacle 50 (arrow B). Perpendicularly to the direction R, the driver seat 12 and the passenger seat 52 are arranged at the same level.

In the case of impact onto the obstacle 50, due to the inertia forces the passenger 48 will perform a movement toward the airbag 20 which has deployed and inflated between the passenger seat 52 and the driver seat 12 (indicated by arrow P).

Based on the geometry of the airbag 20, in this case the passenger 48 strikes the thorax zone 36 and the head zone 38 of the airbag 20 by his/her thorax and head.

FIG. 5 illustrates a crash situation in which the vehicle moves equally perpendicularly to the longitudinal vehicle direction R toward the obstacle 50. In this case, however, the passenger seat 52 is set back somewhat vis-a-vis the driver seat 12 relative to a plane perpendicular to the direction R.

In this case, too, the passenger 48 is protected by the airbag 20. The head of the passenger 48 is absorbed by the head zone 38 of the airbag 20, especially in the portion which completely covers the headrest 18 of the driver seat 12 laterally and in the height.

FIGS. 6 and 7 illustrate a crash situation in the case of an inclined lateral crash in which the longitudinal vehicle direction B of the vehicle relative to the obstacle 50 is inclined relative to the direction of movement R of the vehicle in the longitudinal vehicle direction.

In the situation shown in FIG. 6 the driver seat 12 and the passenger seat 52 are arranged at the same level related to a plane perpendicular to the direction R.

Also in this case the passenger 48 is caught by the airbag 20 at the driver seat 12. As is clearly shown by the arrow P, in each case the passenger 48 impacts on the head zone 38 of the airbag 20.

In the crash situation illustrated in FIG. 7 the passenger seat 52 and the driver seat 12 are offset against each other related to a plane perpendicular to the longitudinal vehicle direction R, wherein the passenger seat 52 is displaced somewhat backwards again.

In this case, too, the passenger 48 is safely caught by the airbag 20, wherein he/she strikes primarily the thorax zone 36 as well as the entire head zone 38 of the airbag 20, as is made clear by the arrow P.

As is shown by way of the different crash situations, it is sufficient to arrange only one single airbag 20 between the vehicle seats 12, 52 so as to be able to safely protect both the driver 40 and the passenger 48.

In the case of crash on the passenger side, the airbag 20 inversely serves as protection for the driver. It is also possible, as a matter of course, to mount the airbag 20 on the passenger seat 52 or to provide a further airbag on the passenger seat 52.

In the vehicle further known airbags can be arranged in the area of the side walls 46, in the steering wheel and/or an instrument panel apart from the illustrated airbag 20, as a matter of course.

1-10. (canceled)

11. A vehicle occupant protection system for a vehicle having at least two vehicle seats, the vehicle occupant protection system comprising an airbag (20) which in the folded state is accommodated in a backrest (14) of a first vehicle seat (12) and in the deployed state extends between the first and the second seat (12, 52) of the vehicle,
wherein the airbag (20) has a thorax zone (36) for laterally covering in its inflated state the thorax of a vehicle occupant (40) and a head zone (38) for laterally covering in its inflated state the head (42) of a vehicle occupant (40), and
wherein a first fastening portion (22) which is provided directly on an inflator (26) for supplying filling gas for the airbag (20) is provided on the airbag and
a second fastening portion (24) arranged at the thorax zone (36) between the first fastening portion (22) and an upper end (16) of the backrest (14) is provided on the airbag (20).

12. The vehicle occupant protection system according to claim 11, wherein the second fastening portion (24) is directly fastened to a frame (28) of the backrest (14).

13. The vehicle occupant protection system according to claim 11, wherein the second fastening portion (24) is fixed to a fastening component (44) separate from a frame (28) of the backrest (14) which is directly connected to the frame (28) of the backrest (14).

14. The vehicle occupant protection system according to claim 13, wherein the first fastening portion (22) is directly fixed to the fastening component (44).

15. The vehicle occupant protection system according claim 11, wherein the first fastening portion (22) is fastened to the frame (28) of the backrest (14) via fastening bolts of the inflator (26).

16. The vehicle occupant protection system according to claim 11, wherein the airbag (20) has an upper end (41) extending in its inflated state at least to an upper end of a headrest (18) and the second fastening portion (24) is arranged approximately in the middle between an upper end (16) of the backrest (14) and the first fastening portion (22).

17. The vehicle occupant protection system according claim 11, wherein the airbag (20) consists of two cut portions (32, 34) being interconnected along a peripheral mounting (30) and the second fastening portion (24) is arranged at the peripheral mounting (30).

18. The vehicle occupant protection system according to claim 11, wherein the head zone (38) of the airbag (20) in its inflated state has a larger width (B_{K}) than the thorax zone (36) and the deployed airbag (20) especially takes an L shape.

19. The vehicle occupant protection system according to claim 11, wherein the head zone (38) of the airbag (20) in its inflated state completely covers a headrest (18) of the vehicle seat (12) and the head (42) of the vehicle occupant (40).

20. The vehicle occupant protection system according to claim 11, wherein the airbag (20) is configured to catch a vehicle occupant (48) on a neighboring vehicle seat (52).
